(19) United States
(12) Patent Application Publication
(10) Pub. No.: US 2024/0213466 A1
(43) Pub. Date: Jun. 27, 2024

(54) POSITIVE ELECTRODE ACTIVE MATERIAL FOR LITHIUM ION BATTERY, POSITIVE ELECTRODE ACTIVE MATERIAL FOR SODIUM ION BATTERY, POSITIVE ELECTRODE MATERIAL, SOLID-STATE BATTERY, AND METHOD OF PRODUCING POSITIVE ELECTRODE ACTIVE MATERIAL FOR LITHIUM ION BATTERY

(71) Applicant: TOYOTA JIDOSHA KABUSHIKI KAISHA, Toyota-shi (JP)

(72) Inventor: Issei SUGIYAMA, Susono-shi (JP)

(73) Assignee: TOYOTA JIDOSHA KABUSHIKI KAISHA, Toyota-shi (JP)

(21) Appl. No.: 18/385,934

(22) Filed: Nov. 1, 2023

(30) Foreign Application Priority Data
Dec. 23, 2022 (JP) 2022-207675

(51) Int. Cl. H01M 4/525; H01M 4/485; H01M 4/505; H01M 10/0525

(52) U.S. Cl. CPC H01M 4/525; H01M 4/485; H01M 4/505; H01M 10/0525; H01M 2004/028

(57) ABSTRACT

A positive electrode active material for a lithium ion battery includes, in X-ray diffraction measurement results, three or more peaks in a 2θ range of from 64° to 70° and one peak in a 2θ range of from 15° to 20°, and the positive electrode active material belongs to the space group Cmca.

### CROSS-REFERENCE TO RELATED APPLICATION

This application is based on and claims priority under 35 USC 119 from Japanese Patent Application No. 2022-207675 filed on Dec. 23, 2022, the disclosure of which is incorporated by reference herein.

### BACKGROUND

### Technical Field

The present disclosure relates to a positive electrode active material for a lithium ion battery, a positive electrode active material for a sodium ion battery, a positive electrode material, a solid-state battery, and a method of producing a positive electrode active material for a lithium ion battery.

### Related Art

A positive electrode active material having at least one type of structure selected from an O2 structure, a T #2 structure, or an O6 structure is stable up to a high potential, and thus has a large charge/discharge capacity when it is charged/discharged in a high potential region.

Japanese Patent Application Laid-open (JP-A) No. 2014-186937 proposes a positive electrode active material use in a non-aqueous electrolyte secondary battery, wherein the positive electrode active material has a layered structure and includes a lithium-containing transition metal oxide in which a main arrangement of a transition metal, oxygen, and lithium is represented by an O2 structure, the lithium-containing transition metal oxide has Li, Mn, and an element M in a lithium-containing transition metal layer in the layered structure and represented by the general composition formula Liₓ[Li_{α}(MnₐM_{b})_{1-α}]O₂, where 0.5<x<1.1, 0.1<α<0.33, 0.67<a<0.97, and 0.03<b<0.33, and M includes at least one or more elements selected from the group consisting of Ni, Mg, Ti, Fe, Sn, Zr, Nb, Mo, W, and Bi.”

Furthermore, JP-A No. 2010-92824 proposes a positive electrode active material for a non-aqueous electrolyte secondary battery, wherein the electric potential P(V) of a lithium-containing layered oxide LiₐN_{ab}M_{c}O_{2±α}(0.5≤a≤1.3, 0≤b≤0.01, 0.90≤c≤1.10, 0≤α≤0.3, and M is at least one element selected from manganese, cobalt, nickel, iron, aluminum, molybdenum, zirconium, and magnesium) belonging to the space group P6₃mc is in the range of 4.8≤P≤5.0 (vs. Li/Li+), a and c represent the molar ratios of lithium and M, respectively, and the ratio of a when c is converted to 1.0 is in the range of 0.08≤a≤0.12.”

### SUMMARY

The structure of a positive electrode active material having at least one type of structure selected from an O2 structure, a T #2 structure, or an O6 structure changes between the O2 structure, the T #2 structure, and the O6 structure in accompaniment with charging and discharging. Specifically, the structure changes in the order of the O2 structure, the T #2 structure, the O6 structure, and the O2 structure, as the order from the structure having the highest Li content to the structure having the lowest Li content. The volume of the positive electrode active material expands and contracts to a large extent accompanying this change in structure, so sometimes cracks occur in the positive electrode active material. When this happens, the conduction path for the electrons is cut off, and the capacity retention rate after repeated charge and discharge cycles tends to decrease.

Thus, it is a problem to be solved by an embodiment of the present disclosure to provide a positive electrode active material for a lithium ion battery with which a battery with a high initial discharge capacity and a high capacity retention rate after repeated charge and discharge cycles can be obtained.

It is a problem to be solved by another embodiment of the present disclosure to provide a positive electrode active material for a sodium ion battery with which a battery with a high initial discharge capacity and a high capacity retention rate after repeated charge and discharge cycles can be obtained.

It is a problem to be solved by another embodiment of the present disclosure to provide a positive electrode material with which a battery with a high initial discharge capacity and a high capacity retention rate after repeated charge and discharge cycles can be obtained.

It is a problem to be solved by another embodiment of the present disclosure to provide a solid-state battery with a high initial discharge capacity and a high capacity retention rate after repeated charge and discharge cycles.

It is a problem to be solved by another embodiment of the present disclosure to provide a method of producing a positive electrode active material with which a battery with a high initial discharge capacity and a high capacity retention rate after repeated charge and discharge cycles can be obtained.

### Means for Solving the Above Problems Include the Following Means

A first aspect of the present disclosure provides a positive electrode active material for a lithium ion battery, comprising, in X-ray diffraction measurement results, three or more peaks in a 2θ range of from 64° to 70° and one peak in a 2θ range of from 15° to 20°,
the positive electrode active material belonging to the space group Cmca.

A second aspect of the present disclosure provides the positive electrode active material for a lithium ion battery of the first aspect, wherein the positive electrode active material is a compound represented by the following Formula 1:

$${Li}_{a} {Na}_{b} {Mn}_{x - p} {Ni}_{y - q} {Co}_{z - r} {M}_{p + q + r} {O}_{2} \qquad Formula 1$$

wherein, in Formula 1, a, b, x, y, z, p, q, and r are numbers satisfying 0≤a≤1, 0≤b<0.05, x+y+z=1, and 0≤p+q+r≤0.20, and M represents at least one selected from the group consisting of B, Mg, Al, K, Ca, Ti, Cr, Ga, Zr, Nb, Mo, and W.

A third aspect of the present disclosure provides a positive electrode active material for a sodium ion battery, including a compound represented by the following Formula 2:

$${Na}_{c} {Mn}_{x - p} {Ni}_{y - q} {Co}_{z - r} {M}_{p + q + r} {O}_{2} \qquad Formula 2$$

wherein, in Formula 2, c, x, y, z, p, q, and r are numbers satisfying 0.5≤c≤0.65, x+y+z=1, and 0≤p+q+r≤0.20, and M represents at least one selected from the group consisting of Li, B, Mg, Al, K, Ca, Ti, Cr, Ga, Zr, Nb, Mo, and W.

A fourth aspect of the present disclosure provides a positive electrode material, including the positive electrode active material for a lithium ion battery of the first or second aspect.

A fifth aspect of the present disclosure provides a solid-state battery, including the positive electrode active material for a lithium ion battery of the first or second aspect.

A sixth aspect of the present disclosure provides a method of producing a positive electrode active material for a lithium ion battery, the method including a step of ion-exchanging Na contained in a compound represented by the following Formula 2 with Li:

$${Na}_{c} {Mn}_{x - p} {Ni}_{y - q} {Co}_{z - r} {M}_{p + q + r} {O}_{2} \qquad Formula 2$$

wherein, in Formula 2, c, x, y, z, p, q, and r are numbers satisfying 0.5≤c≤0.65, x+y+z=1, and 0≤p+q+r≤0.20, and M represents at least one selected from the group consisting of Li, B, Mg, Al, K, Ca, Ti, Cr, Ga, Zr, Nb, Mo, and W.

According to an embodiment of the present disclosure, there can be provided a positive electrode active material for a lithium ion battery with which a battery with a high initial discharge capacity and a high capacity retention rate after repeated charge and discharge cycles can be obtained.

According to another embodiment of the present disclosure, there can be provided a positive electrode active material for a sodium ion battery with which a battery with a high initial discharge capacity and a high capacity retention rate after repeated charge and discharge cycles can be obtained.

According to another embodiment of the present disclosure, there can be provided a positive electrode material with which a battery with a high initial discharge capacity and a high capacity retention rate after repeated charge and discharge cycles can be obtained.

According to another embodiment of the present disclosure, there can be provided a solid-state battery with a high initial discharge capacity and a high capacity retention rate after repeated charge and discharge cycles.

According to another embodiment of the present disclosure, there can be provided a method of producing a positive electrode active material with which a battery with a high initial discharge capacity and a high capacity retention rate after repeated charge and discharge cycles can be obtained.

### BRIEF DESCRIPTION OF THE DRAWING

FIG. 1 is a schematic sectional view showing an example of a solid-state battery.

### DETAILED DESCRIPTION

Exemplary embodiments of the present disclosure will be described below. The description and Examples are merely illustrative of the embodiments and are not intended to limit the scope of the invention.

When numerical ranges are given gradationally in the present specification, the upper limit value or the lower limit value given for one numerical range may be replaced with the upper limit value or the lower limit value of another gradationally given numerical range. Furthermore, when numerical ranges are given in the present specification, the upper limit values or the lower limit values of those numerical ranges may be replaced with values described in the Examples.

Reference to a particular component in the specification encompasses a case in which there are two or more substances that correspond to the component.

When plural substances corresponding to a particular component are present in a composition, the amount of the component in a composition indicated in the present specification refers to the total amount of the plural substances present in the composition unless otherwise specified.

The term “step” includes not only an independent step but also a step that is not clearly distinct from other steps, as long as the desired actions of the step of interest is achieved.

### <Positive Electrode Active Material for Lithium Ion Battery>

The positive electrode active material for a lithium ion battery according to the present disclosure comprises, in X-ray diffraction measurement results, three or more peaks in a 2θ range of from 64° to 70° and one peak in a 2θ range of from 15° to 20°, and the positive electrode active material for a lithium ion battery belongs to the space group Cmca.

By virtue of having the above configuration, the positive electrode active material for a lithium ion battery according to the present disclosure is a positive electrode active material for a lithium ion battery with which a battery with a high initial discharge capacity and a high capacity retention rate after repeated charge and discharge cycles can be obtained. We surmise that the reasons therefor are as follows.

The positive electrode active material for a lithium ion battery according to the present disclosure exhibits, in X-ray diffraction measurement results, three or more peaks in a 2θ range of from 64° to 70° and one peak in a 2θ range of from 15° to 20°, and the positive electrode active material for a lithium ion battery belongs to the space group Cmca. By virtue of being given this configuration, the structure of the positive electrode active material for a lithium ion battery is close to a single phase of a T #2 structure. Because of this, changes in structure between an O2 structure and a T #2 structure can be inhibited. For that reason, expansion and contraction in the volume of the positive electrode active material for a lithium ion battery, which accompany changes in structure, can be inhibited. Because of this, cracks less likely occur in the positive electrode active material, and a reduction in the capacity retention rate after repeated charge and discharge cycles is inhibited. Furthermore, because the structure of the positive electrode active material for a lithium ion battery is close to a single phase of a T #2 structure, the charge/discharge capacity is large.

The positive electrode active material for a lithium ion battery according to the present disclosure will be described below.

(Positions at which there are Peaks in X-Ray Diffraction Measurement Results)

The positive electrode active material for a lithium ion battery according to the present disclosure exhibits, in X-ray diffraction measurement results, three or more peaks in a 2θ range of from 64° to 70° and one peak in a 2θ range of from 15° to 20°.

In order to obtain the positive electrode active material for a lithium ion battery with this configuration, it is preferred that the positive electrode active material for a lithium ion battery be produced by the method of producing a positive electrode active material for a lithium ion battery according to the present disclosure.

The number of peaks that are present in a 2θ range of from 64° to 70° and the number of peaks that are present in a 2θ range of from 15° to 20° are measured by X-ray diffraction measurement. As the X-ray diffractometer, the product RINT-2000 made by Rigaku Corporation can be used. A measurement procedure will be described below.

X-ray diffraction measurement is performed at a step of 0.01° and at least 0.1 sec/step so that 2θ covers at least the range of from 10° to 70°. Fitting by the Rietveld method is performed so that S=R_{WP}/R_{c} is 1.3 or less, and the number of peaks separated at that time is counted as the number of peaks. The fitting is performed with respect to the entire measurement range, which includes a 2θ range of from 10° to 70°. In the fitting results, the number of peaks that are present in a 2θ range of from 64° to 70° and the number of peaks that are present in a 2θ range of from 15° to 20° are counted.

### (Space Group)

The positive electrode active material for a lithium ion battery according to the present disclosure belongs to the space group Cmca.

Here, whether or not the material belongs to the space group Cmca is judged from the results of the fitting by the Rietveld method described above. When a phase belonging to the space group Cmca is present at a volume ratio of 90% or more among the phases included in the results of the fitting by the Rietveld method, it is judged that the positive electrode active material belongs to the space group Cmca.

In the positive electrode active material for a lithium ion battery, the phase belonging to the space group Cmca is preferably 95% or more by volume ratio and more preferably 98% or more.

### (Composition Formula of Positive Electrode Active Material for Lithium Ion Battery)

From the standpoint of the initial discharge capacity and the capacity retention rate, it is preferred that the positive electrode active material for a lithium ion battery according to the present disclosure be a compound represented by the following Formula 1.

$${Li}_{a} {Na}_{b} {Mn}_{x - p} {Ni}_{y - q} {Co}_{z - r} {M}_{p + q + r} {O}_{2} \qquad Formula 1$$

In Formula 1 above, a, b, x, y, z, p, q, and r are numbers satisfying 0≤a≤1, 0≤b≤0.05, x+y+z=1, and 0≤p+q+r<0.20, and M represents at least one selected from the group consisting of B, Mg, Al, K, Ca, Ti, Cr, Ga, Zr, Nb, Mo, and W.

x is preferably a number that satisfies 0≤x≤1 and more preferably a number that satisfies 0.1≤x≤1.

y is preferably a number that satisfies 0≤y≤0.5 and more preferably a number that satisfies 0≤y≤0.33.

z is preferably a number that satisfies 0≤z≤1 and more preferably a number that satisfies 0≤z≤0.67.

p is preferably a number that satisfies 0≤p≤0.10.

q is preferably a number that satisfies 0≤q≤0.10.

r is preferably a number that satisfies 0≤r≤0.10.

Specific examples of the positive electrode active material according to the present disclosure include Li_{0.60}Na_{0.00}Mn_{0.50}Ni_{0.20}Co_{0.30}O₂, Li_{0.50}Na_{0.00}Mn_{0.50}Ni_{0.20}Co_{0.30}O₂, Li_{0.60}Na_{0.05}Mn_{0.50}Ni_{0.20}Co_{0.30}O₂, Li_{0.60}Na_{0.00}Mn_{0.67}Ni_{0.33}O₂, Li_{0.60}Na_{0.00}Mn_{0.40}Ni_{0.20}Co_{0.30}Cr_{0.10}O₂, and Li_{0.60}Na_{0.00}Mn_{0.50}Ni_{0.10}Co_{0.30}Mg_{0.10}O₂.

### <Method of Producing Positive Electrode Active Material for Lithium Ion Battery>

A method of producing the positive electrode active material for a lithium ion battery according to the present disclosure includes a step (ion exchange step) of ion-exchanging Na contained in a compound represented by the following Formula 2 with Li.

$${Na}_{c} {Mn}_{x - p} {Ni}_{y - q} {Co}_{z - r} {M}_{p + q + r} {O}_{2} \qquad Formula 2$$

In Formula 2 above, c, x, y, z, p, q, and r are numbers that satisfy 0.5≤c≤0.65, x+y+z=1, and 0<p+q+r≤0.20, and M represents at least one selected from the group consisting of Li, B, Mg, Al, K, Ca, Ti, Cr, Ga, Zr, Nb, Mo, and W.

x is preferably a number that satisfies 0≤x≤1 and more preferably a number that satisfies 0.1≤x≤1.

y is preferably a number that satisfies 0≤y≤0.5 and more preferably a number that satisfies 0≤y≤0.33.

z is preferably a number that satisfies 0≤z≤1 and more preferably a number that satisfies 0≤z≤0.67.

p is preferably a number that satisfies 0≤p≤0.10.

q is preferably a number that satisfies 0≤q≤0.10.

r is preferably a number that satisfies 0≤r≤0.10.

### (Step of Synthesizing Na-Doped Precursor)

The method of producing the positive electrode active material for a lithium ion battery according to the present disclosure may, as needed, include a step of synthesizing a compound (hereinafter also called a Na-doped precursor) represented by Formula 2 above.

The Na-doped precursor is synthesized by known methods.

Specific examples of the Na-doped precursor include Na_{0.60}Mn_{0.5}Ni_{0.2}Co_{0.3}O₂, Na_{0.50}Mn_{0.50}Ni_{0.20}Co_{0.30}O₂, Na_{0.60}Mn_{0.67}Ni_{0.33}O₂, Na_{0.60}Mn_{0.40}Ni_{0.20}Co_{0.30}Cr_{0.10}O₂, and Na_{0.60}Mn_{0.50}Ni_{0.10}Co_{0.30}Mg_{0.10}O₂.

### (Ion Exchange Step)

The ion exchange step is a step of ion-exchanging Na contained in the Na-doped precursor with Li.

For the ion exchange of the Na-doped precursor, a molten salt bed in which lithium nitrate and lithium chloride are mixed can be used.

The temperature conditions during ion exchange are preferably in a range equal to or higher than the temperature at which the molten salt bed melts but less than 320° C.

### <Positive Electrode Active Material for Sodium Ion Battery>

Compounds represented by the following Formula 2 can be effectively utilized as the positive electrode active material for a sodium ion battery.

$${Na}_{c} {Mn}_{x - p} {Ni}_{y - q} {Co}_{z - r} {M}_{p + q + r} {O}_{2} \qquad Formula 2$$

In Formula 2 above, c, x, y, z, p, q, and r are numbers that satisfy 0.5≤c≤0.65, x+y+z=1, and 0<p+q+r<0.20, and M represents at least one selected from the group consisting of Li, B, Mg, Al, K, Ca, Ti, Cr, Ga, Zr, Nb, Mo, and W.

Specific examples of the positive electrode active material for a sodium ion battery according to the present disclosure include Na_{0.60}Mn_{0.5}Ni_{0.2}Co_{0.3}O₂, Na_{0.60}Mn_{0.50}Ni_{0.20}Co_{0.30}O₂, Na_{0.60}Mn_{0.67}Ni_{0.33}O₂, Na_{0.60}Mn_{0.40}Ni_{0.20}Co_{0.30}Cr_{0.10}O₂, and Na_{0.60}Mn_{0.50}Ni_{0.10}Co_{0.30}Mg_{0.10}O₂.

The positive electrode active material for a sodium ion battery according to the present disclosure can be used as the Na-doped precursor in the method of producing the positive electrode active material for a lithium ion battery according to the present disclosure.

### <Positive Electrode Material>

The positive electrode material according to the present disclosure contains a positive electrode active material for a lithium ion battery and may also contain a conductive additive, a solid electrolyte, a binder, and other components as needed.

### (Positive Electrode Active Material for Lithium Ion Battery)

As the positive electrode active material for a lithium ion battery included in the positive electrode material according to the present disclosure, the positive electrode active material for a lithium ion battery according to the present disclosure is applied, and preferred aspects thereof are also the same.

The positive electrode active material for a lithium ion battery included in the positive electrode material according to the present disclosure may also contain another positive electrode active material for a lithium ion battery other than the positive electrode active material for a lithium ion battery according to the present disclosure.

The other positive electrode active material for a lithium ion battery preferably includes a lithium complex oxide. The lithium complex oxide may contain at least one selected from the group consisting of F, Cl, N, S. Br, and I. Furthermore, the lithium complex oxide may have a crystalline structure belonging to at least one space group selected from the space groups R-3m, Immm, or P63-mmc (also called P63mc or P6/mmc). Furthermore, the main array of the transition metal, oxygen, and lithium in the lithium complex oxide may have an O2 structure.

Examples of lithium complex oxides having a crystalline structure belonging to R-3m include compounds represented by LiₓMe_{y}O_{α}X_{β} (in which Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X represents at least one selected from the group consisting of F, Cl, N, S, Br, and I, and x, y, α, and ß satisfy 0.5≤x≤1.5, 0.5≤y≤1.0, 1≤α<2, and 0<β ≤1).

Examples of lithium complex oxides having a crystalline structure belonging to Immm include complex oxides represented by LiₓM¹A¹₂ (in which x1 satisfies 1.5≤x1≤2.3, M¹ includes at least one selected from the group consisting of Ni, Co, Mn, Cu, and Fe, and A¹ includes at least oxygen, and the proportion of oxygen in A¹ is 85 at % or more) (a specific example is Li₂NiO₂) and complex oxides represented by Liₓ₁M^{1A}₁₋ₓ₂M^{1B}ₓ₂O_{2-y}A²_{y} (in which 0≤x2≤0.5 and 0≤y<0.3 and at least one of x2 and y is not 0, M^{1A} represents at least one selected from the group consisting of Ni, Co, Mn, Cu, and Fe, M^{1B} represents at least one selected from the group consisting of Al, Mg, Sc, Ti, Cr, V, Zn, Ga, Zr, Mo, Nb, Ta, and W, and A2 represents at least one selected from the group consisting of F, Cl, Br, S, and P).

Examples of lithium complex oxides having a crystalline structure belonging to P63-mmc include complex oxides represented by M1ₓM2ₓO₂ (in which M1 represents an alkali metal (preferably at least one of Na or K), M2 represents a transition metal (preferably at least one selected from the group consisting of Mn, Ni, Co, and Fe), and x+y satisfies 0<x+y≤2).

Examples of lithium complex oxides having an (2 structure include complex oxides represented by Liₓ[Li_{α}(Mn_{α}Co_{b}M_{c})_{1-α}]O₂ (in which x, α, a, b, and c satisfy 0.5<x<1.1, 0.1<a<0.33, 0.17<a<0.93, 0.03<b<0.50, 0.04<c<0.33, and M represents at least one selected from the group consisting of Ni, Mg, Ti, Fe, Sn, Zr, Nb, Mo, W, and Bi), and specific examples thereof include Li_{0.744}[Li_{0.145} Mn_{0.625}Co_{0.115}Ni_{0.115}]O₂.

An aspect in which at least part of the surface of the positive electrode active material is coated with a sulfide solid electrolyte, an oxide solid electrolyte, or a halide solid electrolyte is more preferred. As the halide solid electrolyte coating at least part of the surface of the positive electrode active material, Li_{6-(4-x)b}(Ti₁₋ₓAlₓ)_{b}F₆ (0<x<1 and 0<b≤1.5) [LTAF electrolyte] is preferred.

### (Conductive Additive)

Examples of conductive additives include carbon materials, metal materials, and conductive polymer materials. Examples of carbon materials include carbon black (e.g., acetylene black, furnace black, Ketjen black), fibrous carbon (e.g., vapor-grown carbon fibers, carbon nanotubes, carbon nanofibers), graphite, and carbon fluoride. Examples of metal materials include metal powders (e.g., aluminum powder), conductive whiskers (e.g., zinc oxide, potassium titanate), and conductive metal oxides (e.g., titanium oxide). Examples of conductive polymer materials include polyaniline, polypyrrole, and polythiophene. Just one conductive additive may be used by itself, or two or more conductive additives may be mixed together and used.

### (Solid Electrolyte)

It is preferred that the solid electrolyte include at least one solid electrolyte species selected from the solid electrolyte group consisting of a sulfide solid electrolyte, an oxide solid electrolyte, and a halide solid electrolyte.

The sulfide solid electrolyte contains sulfur (S) as the main anion element and also, for example, preferably contains an Li element and an A element. The A element is at least one selected from the group consisting of P, As, Sb, Si, Ge, Sn, B, Al, Ga, and In. The sulfide solid electrolyte may further contain at least one of O or a halogen element. Examples of the halogen element (X) include F, Cl, Br, and I. The composition of the sulfide solid electrolyte is not particularly limited, and examples include xLi₂S·(100−x)P₂S₅(70≤x≤80) and yLiI·zLiBr·(100−y−z)(xLi₂S·(1−x)P₂S₅) (0.7≤x≤0.8, 0≤y≤30, 0<z<30). The sulfide solid electrolyte may have the composition represented by General Formula (1) below.

$${Li}_{a} {Na}_{b} {Mn}_{x - p} {Ni}_{y - q} {Co}_{z - r} {M}_{p + q + r} {O}_{2} \qquad Formula ( 1 )$$

In Formula (1), at least part of Ge may be substituted with at least one selected from the group consisting of Sb, Si, Sn, B, Al, Ga, In, Ti, Zr, V, and Nb. Furthermore, at least part of P may be substituted with at least one selected from the group consisting of Sb, Si, Sn, B, Al, Ga, In, Ti, Zr, V, and Nb. Part of Li may be substituted with at least one selected from the group consisting of Na, K, Mg, Ca, and Zn. Part of S may be substituted with a halogen. The halogen is at least one of F, Cl, Br, or I.

The oxide solid electrolyte contains oxygen (O) as the main anion element, and may contain an Li element and a Q element (Q representing at least one of Nb, B, Al, Si, P, Ti, Zr, Mo, W, or S). Examples of oxide solid electrolytes include garnet-type solid electrolytes, perovskite-type solid electrolytes, NASICON-type solid electrolytes, Li—P—O-based solid electrolytes, and Li—B—O—based solid electrolytes. Example of garnet-type solid electrolytes include Li₇La₃Zr₂O₁₂, Li₇₋ₓLa₃(Zr₂₋ₓNbₓ)O₁₂(0≤x≤2), and Li₅La₃Nb₂O₁₂. Examples of perovskite-type solid electrolytes include (Li,La)TiO₃, (Li,La)NbO₃, and (Li,Sr)(Ta,Zr)O₃. Examples of NASICON-type solid electrolytes include Li(Al, Ti)(PO₄)₃ and Li(Al,Ga)(PO₄)₃. Examples of Li—P—O—based solid electrolytes include Li₃PO₄ and LIPON (a compound in which part of O in Li₃PO₄ is substituted with N), and examples of Li—B—O-based solid electrolytes include Li₃BO₃ and compounds obtained by substituting part of O in Li₃BO₃ with C.

As the halide solid electrolyte, a solid electrolyte including Li, M, and X (M representing at least one of Ti, Al, or Y, and X representing F, Cl, or Br) is preferred. Specifically, Li_{6-3z}Y_{z}X₆ (in which X represents Cl or Br, and z satisfies 0<z<2) and Li_{6-(4-x)b}(Ti₁₋ₓAlₓ)_{b}F₆(0<x<1, 0<b≤1.5) are preferred. Among Li_{6-3z}Y_{z}X₆, in terms of having superior lithium ion conductivity, Li₃YX₆ (in which X represents Cl or Br) is more preferred, and Li₃YCl₆ is even more preferred. Furthermore, it is preferred that Li_{6-(4-x)b}(Ti₁₋ₓAlₓ)_{b}F₆ (0<x<1, 0<b≤1.5) be included together with a solid electrolyte such as a sulfide solid electrolyte from the standpoint of inhibiting oxidative decomposition of the sulfide solid electrolyte.

### (Binder)

Examples of binders include vinyl halide resins, rubbers, and polyolefin resins. Examples of vinyl halide resins include polyvinylidene fluoride (PVdF) and a copolymer of polyvinylidene fluoride and hexafluoropropylene (PVdF-HFP). Examples of polyolefin resins include butadiene rubber (BR), acrylate-butadiene rubber (ABR), styrene-butadiene rubber (SBR), acrylonitrile-butadiene rubber (NBR), and butyl rubber (isobutylene-isoprene rubber). Examples of polyolefin resins include polyethylene and polypropylene. The binder may be a diene-based rubber including a double bond in its main chain, such as a butadiene-based rubber in which butadiene occupies 30 mol % or more of the entire rubber.

### (Other Components)

Examples of other components include oxide solid electrolytes, halide solid electrolytes, thickeners, surfactants, dispersants, wetting agents, antifoaming agents, and solvents.

### <Solid-State Battery>

The solid-state battery according to the present disclosure includes the positive electrode active material for a lithium ion battery according to the present disclosure.

The solid-state battery according to the present disclosure preferably includes a positive electrode layer, a negative electrode layer, and an electrolyte layer or a separator disposed between the positive electrode layer and the negative electrode layer. The positive electrode layer preferably includes the positive electrode material of the present disclosure.

### (Battery Structure)

The solid-state battery includes what is called an all-solid-state battery which uses an inorganic solid electrolyte as the electrolyte (in which the content of the electrolyte solution serving as an electrolyte is less than 10% by mass relative to the total amount of electrolytes).

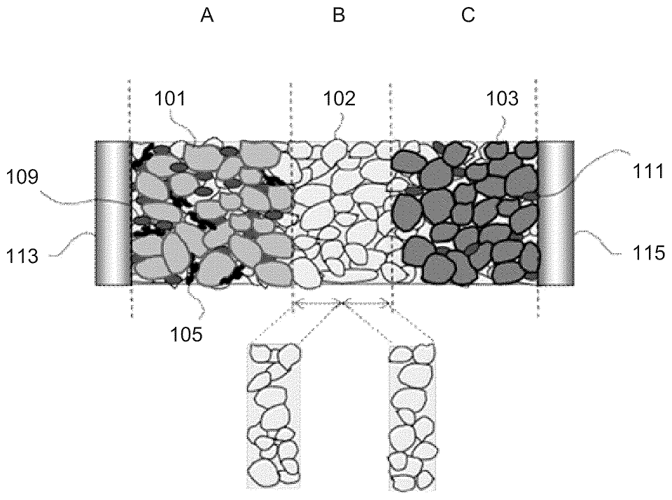

The structure of the solid-state battery of the present disclosure may be a structure including a positive electrode current collector, a positive electrode layer, a solid electrolyte layer, a negative electrode layer, and a negative electrode current collector in this order, and, for example, may be the structure shown in FIG. 1. Solid electrolyte layer B in FIG. 1 may have a two-layer structure. FIG. 1 is a schematic sectional view showing an example of a solid-state battery. The solid-state battery shown in FIG. 1 includes a negative electrode, which includes a negative electrode current collector 113 and a negative electrode layer A, a solid electrolyte layer B, and a positive electrode, which includes a positive electrode current collector 115 and a positive electrode layer C. The negative electrode layer A includes a negative electrode active material 101, a conductive additive 105, a binder 109, and a solid electrolyte 102. The positive electrode layer C includes a positive electrode active material 103, a binder 111, and the solid electrolyte 102.

When a set of the positive electrode layer, the solid electrolyte layer, and the negative electrode layer serves as a power generation unit, the solid-state battery may have just one or may have two or more power generation units. When the solid-state battery has two or more power generation units, those power generation units may be connected in series or in parallel.

The solid-state battery may be configured by sealing, with resin, stack edge faces (side faces) of a stacked structure of the positive electrode layer/the solid electrolyte layer/the negative electrode layer. The current collectors of the electrodes may have a configuration in which a buffer layer, an elastic layer, or a positive temperature coefficient (PTC) thermistor layer is disposed on the surface.

The shape of the solid-state battery is not particularly limited and, for example, may be coin-shaped, cylindrical, rectangular, sheet-shaped, button-shaped, flat-shaped, or stacked.

### (Electrolyte Layer and Separator)

The solid-state battery includes an electrolyte layer or a separator.

The electrolyte layer may be a layer including a solid electrolyte.

When the electrolyte layer is a layer including a solid electrolyte (a solid electrolyte layer), the solid electrolyte layer preferably includes one selected from the group consisting of a sulfide solid electrolyte, an oxide solid electrolyte, and a halide solid electrolyte.

As specific examples of the sulfide solid electrolyte, the oxide solid electrolyte, and the halide solid electrolyte, the same ones as those described above are applied.

The solid electrolyte layer may have a single-layer structure or a multi-layer structure comprising two or more layers.

The solid electrolyte layer may or may not include a binder. As examples of the binder that can be included in the solid electrolyte layer, the same binders as those described above are applied.

As the separator, a porous sheet (film) formed from a resin such as polyethylene (PE), polypropylene (PP), polyester, cellulose, or polyamide can be used.

### (Positive Electrode Layer)

The solid-state battery includes a positive electrode layer. The positive electrode layer includes the positive electrode material of the present disclosure.

### (Positive Electrode Current Collector)

The solid-state battery may further include a positive electrode current collector. The positive electrode current collector collects current for the positive electrode layer. The positive electrode current collector is disposed at a position at a side opposite to the electrolyte layer (or the separator) in relation to the positive electrode layer.

Examples of positive electrode current collectors include stainless steel, aluminum, copper, nickel, iron, titanium, and carbon, with aluminum alloy foil or aluminum foil being preferred. Aluminum alloy foil and aluminum foil may be produced using powder. The shape of the positive electrode current collector is, for example, foil-shape or mesh-shape.

The positive electrode current collector may have a configuration in which a buffer layer, an elastic layer, or a positive temperature coefficient (PTC) thermistor layer is disposed on the surface.

### (Negative Electrode Layer)

The solid-state battery includes a negative electrode layer. The negative electrode layer contains a negative electrode active material. The negative electrode layer may contain at least one of a solid electrolyte for a negative electrode, a conductive additive, and a binder as needed. Examples of negative electrode active materials include Li-based active materials such as metallic lithium, carbon-based active materials such as graphite, oxide-based active materials such as lithium titanate, and Si-based active materials such as simple Si. Examples of the conductive additive, the solid electrolyte for a negative electrode, and the binder used in the negative electrode layer include the same ones as the foregoing examples given for the conductive additive included in the positive electrode layer, the solid electrolyte included in the solid electrolyte layer, and the binder.

### (Negative Electrode Current Collector)

The solid-state battery may further include a negative electrode current collector. The negative electrode current collector collects current for the negative electrode layer. The negative electrode current collector is disposed at a position at a side opposite to the electrolyte layer (or the separator) in relation to the negative electrode layer.

Examples of negative electrode current collectors include stainless steel, aluminum, copper, nickel, iron, titanium, and carbon, with copper being preferred. The shape of the negative electrode current collector is, for example, foil-shape or mesh-shape.

The negative electrode current collector may have a configuration in which a buffer layer, an elastic layer, or a positive temperature coefficient (PTC) thermistor layer is disposed on the surface.

### <Method of Producing Solid-state Battery>

The method of producing a solid-state battery according to the present disclosure includes:
a step (preparation step) of preparing a positive electrode layer, a negative electrode layer, and an electrolyte layer or a separator; and
a step (stacking step) of stacking the positive electrode layer, the electrolyte layer or the separator, and the negative electrode layer in this order.

### (Preparation Step)

The preparation step is a step of preparing a positive electrode layer, a negative electrode layer, and an electrolyte layer or a separator.

The method of preparing the positive electrode layer, the negative electrode layer, and the electrolyte layer is not particularly limited, but it is preferred that they be prepared by kneading the components that can be contained in the positive electrode layer, the negative electrode layer, and the electrolyte layer to obtain a slurry, then applying the slurry to a substrate, drying the slurry to obtain a dry film, and pressing the dry film.

The method of kneading the components that can be contained in the positive electrode layer when obtaining the slurry is not particularly limited, and examples thereof include a method of kneading using a kneading device. Examples of kneading devices include ultrasonic homogenizers, shakers, thin-film rotary mixers, dissolvers, homomixers, kneaders, roll mills, sand mills, attritors, ball mills, vibrator mills, and high-speed impeller mills.

Examples of techniques for pressing the dry film include roll pressing and cold isostatic pressing (CIP).

The pressure during pressing is preferably 0.1 t (ton)/cm₂ or more, more preferably 0.5 t/cm₂ or more, and even more preferably 1 t/cm₂ or more. The pressure during pressing is preferably 10 t/cm₂ or less, more preferably 8 t/cm₂ or less, and even more preferably 6 t/cm₂ or less.

As the separator, a commercially available porous sheet (film) can be used.

### (Stacking Step)

The stacking step is a step of stacking the positive electrode layer, the electrolyte layer or the separator, and the negative electrode in this order.

It is preferred that in the stacking step the positive electrode layer, the electrolyte layer or the separator, and the negative electrode layer that have been prepared in the preparation step be stacked in this order and pressed as needed to obtain a stack (electrode body).

It is preferred that the solid-state battery according to the present disclosure be prepared via the above steps.

### EXAMPLES

Examples will be described below, but the present invention is not in any way limited to these Examples. It will be noted that in the following description, “parts” and “%” are all based on mass unless otherwise specified.

### Example 1

### [Production of Positive Electrode Active Material for Lithium Ion Battery]

### (Step of Synthesizing Na-doped Precursor)

Mn(NO₃)₂·6H₂O, Ni(NO₃)₂·6H₂O, and Co(NO₃)₂·6H₂O were used as raw materials and dissolved in pure water so that the molar ratio of Mn, Ni, and Co was 5:2:3. A Na₂CO₃ solution with a concentration of 12% by mass was prepared, and these two solutions were simultaneously added into a beaker. At this time, the addition rate was controlled so that the pH was 7.0 or more but less than 7.1. After the addition was completed, the mixed solution was stirred for 24 hours at 50° C. and 300 rpm. The obtained reaction product was washed with pure water and centrifuged to separate only the precipitated powder. The obtained powder was dried at 120° C. for 48 hours and then pulverized in an agate mortar to obtain a powder (hereinafter, this powder will be called an “intermediate powder”).

Na₂CO₃ was added to and mixed with the obtained intermediate powder so that the composition ratio was Na_{0.60}Mn_{0.5}Ni_{0.2}Co_{0.3}O₂. The mixed powder was pressed with a load of 2 tons using cold isostatic pressing to prepare pellets. The obtained pellets were pre-fired in the atmosphere at 600° C. for 6 hours and fired at 700° C. for 24 hours, then cooled to 250° C. at 3° C./min, and left to cool, thus synthesizing a Na-doped precursor (Na_{0.60}Mn_{0.5}Ni_{0.2}Co_{0.3}O₂).

### (Ion Exchange Step)

A mixed powder was obtained by mixing LiNO₃ and LiCl at a mass ratio of 88.12. The mixed powder was weighed so that the ratio of the number of moles of Li included in the mixed powder to the number of moles of the Na-doped precursor was 10 times. The Na-doped precursor and the mixed powder were mixed, and ion exchange was performed in the atmosphere at 280° C. for 1 hour. After ion exchange, water was added to dissolve the salt, and washing with water was further performed to obtain a positive electrode active material 1 for a lithium ion battery having an O2 structure (Li_{0.58}Mn_{0.50}Ni_{0.20}Co_{0.30}O₂).

### [Production of Solid-State Battery]

### (Preparation Step)

### —Preparation of Positive Electrode Layer—

85 g of the positive electrode active material 1 for a lithium ion battery (ball-milled to a powder) and 10 g of carbon black as a conductive additive were introduced to 125 mL of a solution of solvent n-methylpyrrolidone in which 5 g of polyvinylidene fluoride (PVDF) as a binder was dissolved, and the mixture was kneaded until uniformly mixed to prepare a slurry. The slurry was applied at a basis weight of 6 mg/cm² to one side of a 15 μm-thick A1 positive electrode current collector as a substrate and dried to obtain an electrode. Thereafter, the electrode was pressed so that the thickness of the positive electrode layer was 45 μm and the density of the positive electrode layer was 2.4 g/cm³. Finally, the electrode was cut out to a diameter of 16 mm to obtain a positive electrode having a positive electrode layer and a positive electrode current collector.

### —Preparation of Negative Electrode Layer—

A negative electrode layer was obtained by cutting out Li foil to a diameter of 19 mm.

### —Preparation of Separator—

A porous sheet made of PP was prepared as a separator.

### (Stacking Step)

The positive electrode, the separator, and the negative electrode layer were stacked in this order to obtain a stack. It will be noted that the positive electrode was stacked so that the positive electrode layer faced the separator. The stack and a non-aqueous electrolyte (a solution obtained by dissolving lithium hexafluorophosphate (LiPF₆) as a supporting salt at a concentration of 1 mol/L in an ethylene carbonate (EC)/dimethyl carbonate (DMC) mixture with a volume ratio of 3:7) were housed in a coin cell to prepare a CR2032 coin cell battery.

### Example 2

### [Production of Positive Electrode Active Material for Lithium Ion Battery]

A positive electrode active material for a lithium ion battery was obtained by the same procedure as in Example 1 except that in the “(Step of Synthesizing Na-doped Precursor)” Na₂CO₃ was added to the intermediate powder to obtain Na_{0.50}Mn_{0.5}Ni_{0.2}Co_{0.3}O₂. The positive electrode active material for a lithium ion battery served as a positive electrode active material 2 for a lithium ion battery (Li_{0.52}Mn_{0.50}Ni_{0.20}Co_{0.30}O₂).

### [Production of Solid-state Battery]

A coin cell battery was prepared by the same procedure as in Example 1 except that in the “(Preparation Step)—Preparation of Positive Electrode Layer—” the positive electrode active material 1 for a lithium ion battery was replaced with the positive electrode active material 2 for a lithium ion battery.

### Comparative Example 1

### [Production of Positive Electrode Active Material for Lithium Ion Battery]

A positive electrode active material for a lithium ion battery was obtained by the same procedure as in Example 1 except that in the “(Step of Synthesizing Na-doped Precursor)” Na₂CO₃ was added to the intermediate powder to obtain Na_{0.70}Mn_{0.5}Ni_{0.2}Co_{0.3}O₂. The positive electrode active material for a lithium ion battery served as a positive electrode active material Cl for a lithium ion battery (Li_{0.67}Mn_{0.50}Ni_{0.20}Co_{0.30}O₂).

### [Production of Solid-state Battery]

A coin cell battery was prepared by the same procedure as in Example 1 except that in the “(Preparation Step)—Preparation of Positive Electrode Layer—” the positive electrode active material 1 for a lithium ion battery was replaced with the positive electrode active material Cl for a lithium ion battery.

### Comparative Example 2

### [Production of Positive Electrode Active Material for Lithium Ion Battery]

A positive electrode active material for a lithium ion battery was obtained by the same procedure as in Example 1 except that in the “(Step of Synthesizing Na-doped Precursor)” Na₂CO₃ was added to the intermediate powder to obtain Na_{0.40}Mn_{0.5}Ni_{0.2}Co_{0.3}O₂. The positive electrode active material for a lithium ion battery served as a positive electrode active material C2 for a lithium ion battery (Li_{0.48}Mn_{0.50}Ni_{0.20}Co_{0.30}O₂).

### [Production of Solid-state Battery]

A coin cell battery was prepared by the same procedure as in Example 1 except that in the “(Preparation Step)—Preparation of Positive Electrode Layer—” the positive electrode active material 1 for a lithium ion battery was replaced with the positive electrode active material C2 for a lithium ion battery.

### Comparative Example 3

### [Production of Positive Electrode Active Material for Lithium Ion Battery]

A positive electrode active material for a lithium ion battery was obtained by the same procedure as in Example 1 except that in the “(Step of Synthesizing Na-doped Precursor)” Na₂CO₃ was added to the intermediate powder to obtain Na_{0.65}Mn_{0.5}Ni_{0.2}Co_{0.3}O₂. The positive electrode active material for a lithium ion battery served as a positive electrode active material C3 for a lithium ion battery (Li_{0.62}Mn_{0.50}Ni_{0.20}Co_{0.3}O₂).

### [Production of Solid-state Battery]

A coin cell battery was prepared by the same procedure as in Example 1 except that in the “(Preparation Step)—Preparation of Positive Electrode Layer—” the positive electrode active material 1 for a lithium ion battery was replaced with the positive electrode active material C3 for a lithium ion battery.

### Comparative Example 4

### [Production of Positive Electrode Active Material for Lithium Ion Battery]

Lithium carbonate (Li₂CO₃), manganese oxide (MnO₂), nickel oxide (NiO), and cobalt oxide (Co₂O₃) were mixed in a ball mill. The mixture was pressed with a load of 2 tons using cold isostatic pressing to prepare pellets. The obtained pellets were fired in the atmosphere at 1000° C. for 24 hours to obtain a positive electrode active material C4 for a lithium ion battery (Li_{1.0}Mn_{0.33}Ni_{0.33}Co_{0.33}O₂).

### [Production of Solid-state Battery]

A coin cell battery was prepared by the same procedure as in Example 1 except that in the “(Preparation Step)—Preparation of Positive Electrode Layer—” the positive electrode active material 1 for a lithium ion battery was replaced with the positive electrode active material C4 for a lithium ion battery.

### Comparative Example 5

### [Production of Positive Electrode Active Material for Lithium Ion Battery]

Lithium nitrate (LiNO₃) served as a positive electrode active material C5 for a lithium ion battery.

### [Production of Solid-state Battery]

A coin cell battery was prepared by the same procedure as in Example 1 except that in the “(Preparation Step)—Preparation of Positive Electrode Layer—” the positive electrode active material 1 for a lithium ion battery was replaced with the positive electrode active material C5 for a lithium ion battery.

### <Evaluation>

### (Positions of Peaks in X-ray Diffraction Measurement Results, and Space Group)

Table 1 shows results obtained by calculating, in accordance with the procedures described above, the “number of peaks that are present in a 2θ range of from 64° to 70°”, the “number of peaks that are present in a 2θ range of from 15° to 20°”, and the “space group” of the positive electrode active material for a lithium ion battery included in the battery obtained in each example.

### (Initial Discharge Capacity)

A charge/discharge test was implemented using a galvanostat at a current of 0.1 C, an end-of-charge voltage of 4.8 V, and an end-of-discharge voltage of 2.0 V. Charging was performed first, and after a first charging was completed, the amount of current required for discharging to 2.0 V was calculated, and the initial discharge capacity was calculated by dividing the amount of current by the weight of the active material used for measurement.

(Capacity Retention Rate after 20 Cycles)

A charge/discharge test was implemented under the same conditions as above, and the discharge capacity obtained in the first charge-discharge cycle and the discharge capacity obtained in the twentieth charge-discharge cycle were calculated. The capacity retention rate after 20 cycles was obtained by dividing the discharge capacity obtained in the twentieth cycle by the discharge capacity in the first cycle.

TABLE 1

| | | | | | Battery | |
|---|---|---|---|---|---|---|
| | | | | | | Capacity |
| | | Number of | Number of | | Initial | Retention |
| | | Peaks in a | Peaks in a | | Discharge | Rate after |
| | | range of 2θ = | range of 2θ = | | Capacity | 20 Cycles |
| | Composition Formula | 64° to 70° | 15° to 20° | Space Group | (mAh/g) | (%) |
| Example 1 | Li_{0.58}Mn_{0.50}Ni_{0.20}CO_{0.30}O₂ | 3 | 1 | Cmca | 214.5 | 96.1 |
| Example 2 | Li_{0.58}Mn_{0.50}Ni_{0.20}CO_{0.30}O₂ | 3 | 1 | Cmca | 206.8 | 95.4 |
| Comparative | Li_{0.67}Mn_{0.50}Ni_{0.20}Co_{0.30}O₂ | 1 | 1 | P63mc | 223.4 | 85.7 |
| Example 1 | | | | | | |
| Comparative | Li_{0.48}Mn_{0.50}Ni_{0.20}Co_{0.30}O₂ | 1 | 1 | R-3m | 201.5 | 81.2 |
| Example 2 | | | | | | |
| Comparative | Li_{0.62}Mn_{0.50}Ni_{0.20}Co_{0.30}O₂ | 3 | 2 | P63mc + Cmca | 218.2 | 88.2 |
| Example 3 | | | | | | |
| Comparative | Li_{1.0}Mn_{0.33}Ni_{0.33}Co_{0.33}O₂ | 2 | 1 | R-3m | 192.1 | 97.0 |
| Example 4 | | | | | | |
| Comparative | LiNO₃ | 3 | 0 | R-3c | 5.1 | 67.5 |
| Example 5 | | | | | | |

In Table 1, the “Number of Peaks in a range of 20=64° to 70°” means the number of peaks that are present in a 2θ range of from 64° to 70°.

In Table 1, the “Number of Peaks in a range of 20=15° to 20°” means the number of peaks that are present in a 2θ range of 15° to 20°.

From the above results, it can be seen that with the positive electrode active material for a lithium ion batterys of the Examples, a battery with a high initial discharge capacity and a high capacity retention rate after repeated charge and discharge cycles can be obtained.

What is claimed is:

1. A positive electrode active material for a lithium ion battery, comprising, in X-ray diffraction measurement results, three or more peaks in a 2θ range of from 64° to 70° and one peak in a 2θ range of from 15° to 20°, the positive electrode active material belonging to the space group Cmca.

2. The positive electrode active material for a lithium ion battery according to claim 1, wherein the positive electrode active material is a compound represented by the following Formula 1:
$${Li}_{a} {Na}_{b} {Mn}_{x - p} {Ni}_{y - q} {Co}_{z - r} {M}_{p + q + r} {O}_{2} \qquad Formula 1$$
wherein, in Formula 1, a, b, x, y, z, p, q, and r are numbers satisfying 0≤a≤1, 0≤b≤0.05, x+y+z=1, and 0≤p+q+r≤0.20, and M represents at least one selected from the group consisting of B, Mg, Al, K, Ca, Ti, Cr, Ga, Zr, Nb, Mo, and W.

3. A positive electrode active material for a sodium ion battery, comprising a compound represented by the following Formula 2:
$${Na}_{c} {Mn}_{x - p} {Ni}_{y - q} {Co}_{z - r} {M}_{p + q + r} {O}_{2} \qquad Formula 2$$
wherein, in Formula 2, c, x, y, z, p, q, and r are numbers satisfying 0.5 Sc≤0.65, x+y+z=1, and 0≤p+q+r≤0.20, and M represents at least one selected from the group consisting of Li, B, Mg, Al, K, Ca, Ti, Cr, Ga, Zr, Nb, Mo, and W.

4. A positive electrode material, comprising the positive electrode active material for a lithium ion battery of claim 1.

5. A solid-state battery, comprising the positive electrode active material for a lithium ion battery of claim 1.

6. A method of producing a positive electrode active material for a lithium ion battery, the method comprising ion-exchanging Na contained in a compound represented by the following Formula 2 with Li:
$${Na}_{c} {Mn}_{x - p} {Ni}_{y - q} {Co}_{z - r} {M}_{p + q + r} {O}_{2} \qquad Formula 2$$
wherein, in Formula 2, c, x, y, z, p, q, and r are numbers satisfying 0.5≤c≤0.65, x+y+z=1, and 0≤p+q+r≤0.20, and M represents at least one selected from the group consisting of Li, B, Mg, Al, K, Ca, Ti, Cr, Ga, Zr, Nb, Mo, and W.
